(19) United States
(12) Patent Application Publication
(10) Pub. No.: US 2004/0090629 A1
(43) Pub. Date: May 13, 2004

(54) Diffraction order selection for optical metrology simulation

(76) Inventors: Emmanuel Drege, San Jose, CA (US); Srinivas Doddi, Fremont, CA (US); Vi Vuong, Fremont, CA (US); Junwei Bao, Santa Clara, CA (US)

Correspondence Address: Peter J. Yim, Morrison & Foerster LLP, 425 Market Street, San Francisco, CA, 94105-2482, US

(21) Appl. No.: 10/290,792

(22) Filed: Nov. 8, 2002

(51) Int. Cl. G01N 21/41

(52) U.S. Cl. 356/445

(57) ABSTRACT

Using one or more selection criteria, diffraction orders for use in optical metrology simulation utilizing rigorous coupled-wave analysis are selected per wavelength. The diffraction orders selected may be symmetric or asymmetric. In an exemplary embodiment, the selection process utilizes one or more termination criteria. The selection of diffraction orders balances the amount of diffraction information needed for accurate optical metrology profile data determination and the number of calculation steps required for regression or library-based approaches of converting diffraction signals to corresponding structure profiles.

### CROSS-REFERENCE TO RELATED APPLICATIONS

This application relates to co-pending U.S. patent application Ser. No. 09/727,530, entitled “System and Method for Real-Time Library Generation of Grating Profiles” by Jakatdar, et al., filed on Nov. 28, 2000; to co-pending U.S. patent application Ser. No. 09/923,578, to co-pending U.S. patent application Ser. No. 10/206,491, entitled “Model and Parameter Selection for Optical Metrology”, by Vuong et al., filed on Jul. 25, 2002, and to co-pending U.S. patent application Ser. No. 09/770,997, entitled “Caching of Intra-layer Calculations for Rapid Rigorous Couple-Wave Analyses”, by Niu et al., filed on Jan. 26, 2000 all owned by the assignee of this application and incorporated herein by reference.

### BACKGROUND OF INVENTION 1. Field of Invention

The invention relates to optical metrology and more particularly to the selection of diffraction orders of a diffraction signal for use in optical metrology measurement, processing, and/or simulation utilizing rigorous coupled-wave analysis (RCWA), differential technique or similar algorithms. 2. Related Art

RCWA, differential technique, and similar algorithms have been widely used for the study and design of diffraction structures. The profiles of periodic structures are approximated by a given number of sufficiently thin planar grating slabs. Specifically, RCWA involves three main steps, namely, the Fourier expansion of the field inside the grating; calculation of the eigenvalues and eigenvectors of a constant coefficient matrix that characterizes the diffracted signal; and solution of a linear system deduced from the boundary matching conditions. RCWA divides the problem into three distinct spatial regions: 1) the ambient region supporting the incident plane wave field and a summation over all reflected diffracted orders, 2) the grating structure and underlying unpatterned layers in which the wave field is treated as a superposition of modes associated with each diffracted order, and 3) the substrate containing the transmitted wave field. For a detailed description on the use of RCWA for calculating the simulated diffraction signal off a periodic structure, refer to co-pending U.S. patent application Ser. No. 09/770,997, entitled “Caching of Intra-layer Calculations for Rapid Rigorous Couple-Wave Analyses”, by Niu et al., filed on Jan. 26, 2000 incorporated herein in its entirety by reference.

The accuracy of the RCWA solution depends, in part, on the number of terms retained in the space-harmonic expansion of the wave fields, with conservation of energy being satisfied in general. The number of terms retained is a function of the number of diffraction orders considered during the calculations. Efficient generation of a simulated diffraction signal for a given profile involves selection of the optimal set of diffraction orders at each wavelength for both transverse-magnetic (TM) and/or transverse-electric (TE) components of the diffraction signal. Mathematically, the more diffraction orders are selected, the more accurate the simulations. However, the higher the number of orders, the more computation is required for calculating the simulated diffraction signal. Moreover, the computation time is a nonlinear function of the number of orders used. Thus, it is useful to minimize the number of orders simulated at each wavelength. However, one cannot arbitrarily minimize the number of orders as this might result in loss of information. Since the selection of diffraction orders is application specific, efficient approaches for diffraction order selection are desirable.

### SUMMARY OF INVENTION

In one exemplary embodiment, diffraction orders for use in optical metrology utilizing RCWA, differential technique or other similar techniques are selected per wavelength. The diffraction orders selected may be symmetric or asymmetric (with respect to the specular diffraction order). In one embodiment, the selection process utilizes one or more termination criteria such as cost function and/or goodness of fit. Within this embodiment, the selection process can be either coupled to a straightforward choice of orders symmetrically around the specular order, or asymmetrically considering the properties of the wave vector. The selection of diffraction orders balances the amount of diffraction information needed for accurate optical metrology profile data determination and the computation time required in any of the steps needed to convert measured diffraction signals to corresponding structure profiles, such as, but not limited to, regression or library generation.

### BRIEF DESCRIPTION OF DRAWINGS

FIG. 1 is an architectural diagram illustrating an exemplary embodiment where optical metrology can be utilized to determine the profiles of structures on a semiconductor wafer.

FIG. 2A is an architectural diagram illustrating orders of a diffraction signal off a periodic structure.

FIG. 2B includes a graph illustrating cost as a function of the number of diffraction orders and a graph illustrating time required to create a library of simulated diffraction signals as a function of the number of diffraction orders considered in the calculations, assuming a given computer system.

FIG. 3A is a flow chart of an exemplary process using a high starting number of diffraction orders whereas FIG. 3B is a flow chart of an exemplary process using a low starting number of diffraction orders.

FIG. 4A is an exemplary flow chart for determining the diffraction orders to include in asymmetrical order selection.

FIG. 4B is a top view of a periodic structure illustrating the fixed coordinate system.

FIG. 5A and 5B are graphs illustrating convergence of the TM component of the diffraction signal for a given wavelength as a function of diffraction orders.

FIG. 6 is a selected diffraction order data store layout in an exemplary embodiment.

FIG. 7 is an architectural diagram of a diffraction order selector in an exemplary embodiment.

FIG. 8 is an architectural diagram illustrating an exemplary embodiment in a real-time critical dimension (CD) estimator.

FIG. 9 is an architectural diagram of an exemplary embodiment for creating and using a library of simulated diffraction signals and profiles utilizing selected diffraction orders.

FIG. 10A is a graph illustrating the number of selected diffraction orders for TE component of a diffraction signal in an exemplary embodiment utilizing an ellipsometer whereas FIG. 10B is a graph illustrating the number of selected diffraction orders for TM component of the diffraction signal as a function of wavelength.

FIG. 11A and 11B are TE graphs illustrating the real and imaginary portions respectively of two simulated diffraction signals off a hypothetical structure, one using fifteen diffraction orders for all wavelengths and the other using diffraction orders selected with the methods and principles of the present invention.

FIG. 12A and 12B are TM graphs illustrating the real and imaginary portions of two simulated diffraction signals off a hypothetical structure, one using fifteen diffraction orders for all wavelengths and the other using diffraction orders selected with the methods and principles of the present invention.

FIG. 13 is a graph illustrating reflectance difference as a function of the number of diffraction orders used in optical metrology calculations with one using symmetrical diffraction orders and another using asymmetrical diffraction orders.

### DETAILED DESCRIPTION OF EXEMPLARY EMBODIMENT (S)

In order to facilitate the description of the present invention, an ellipsometric optical metrology system is used to illustrate the concepts and principles. It is understood that the same concepts and principles equally apply to the other optical metrology systems such as reflectometric systems and the like. In a similar manner, a semiconductor wafer may be utilized to illustrate an application of the concept. Again, the methods and processes equally apply to other work pieces that have periodic structures.

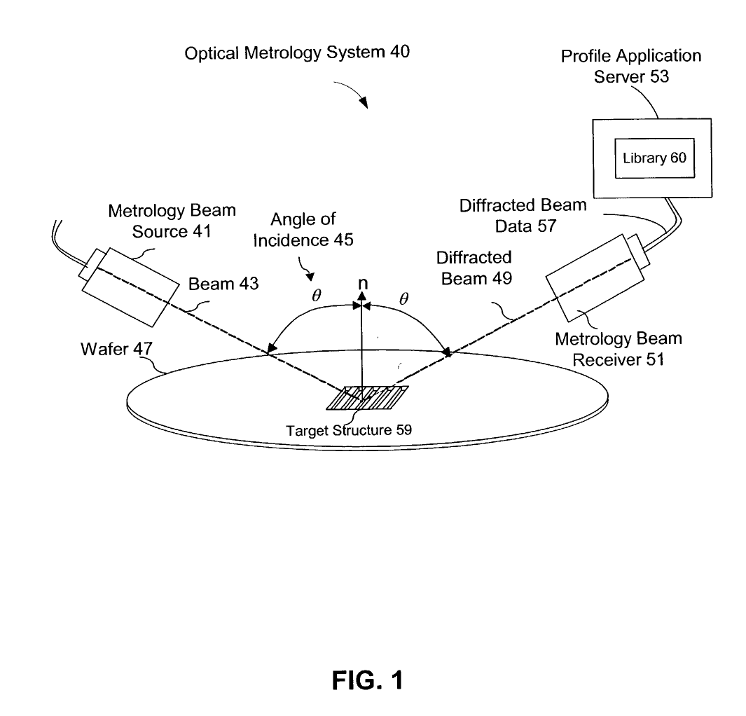

FIG. 1 is an architectural diagram illustrating an exemplary embodiment where optical metrology can be utilized to determine the profiles of structures on a semiconductor wafer. The optical metrology system 40 includes a metrology beam source 41 projecting a beam 43 at the target structure 59 of a wafer 47. The metrology beam 43 is projected at an incidence angle θ towards the target structure 59. The diffraction beam 49 is measured by a metrology beam receiver 51. The diffraction beam data 57 is transmitted to a profile application server 53. The profile application server 53 compares the measured diffraction beam data 57 against a library 60 of calculated diffraction beam data representing varying combinations of critical dimensions of the target structure and resolution. In one exemplary embodiment, the library 60 instance best matching the measured diffraction beam data 57 is selected. It is understood that although a library of diffraction spectra or signals and associated profiles is frequently used to illustrate concepts and principles, the present invention equally applies to a data space comprising simulated diffraction signals and associated set of profile parameters, such as in regression, neural net, and similar methods used for profile extraction. The profile and associated critical dimensions of the selected library 60 instance correspond to the cross-sectional profile and critical dimensions of the features of the target structure 59. The optical metrology system 40 may utilize a reflectometer, an ellipsometer, or other optical metrology device to measure the diffraction beam or signal. An optical metrology system is described in co-pending U.S. patent application Ser. No. 09/727,530 entitled “System and Method for Real-Time Library Generation of Grating Profiles” by Jakatdar, et al., filed on Nov. 28, 2000, and is incorporated in its entirety herein by reference. Other exemplary embodiments of the present invention in optical metrology not requiring the use of libraries are discussed below.

To facilitate description of this invention, graphs of diffraction signals off IC structures measured using an ellipsometer, e.g., TE and TM components of the diffraction signals, will be utilized. It is understood that although ellipsometry and ellipsometric devices are discussed in exemplary embodiments, the present concepts and principle can apply to reflectometers and like devices and systems.

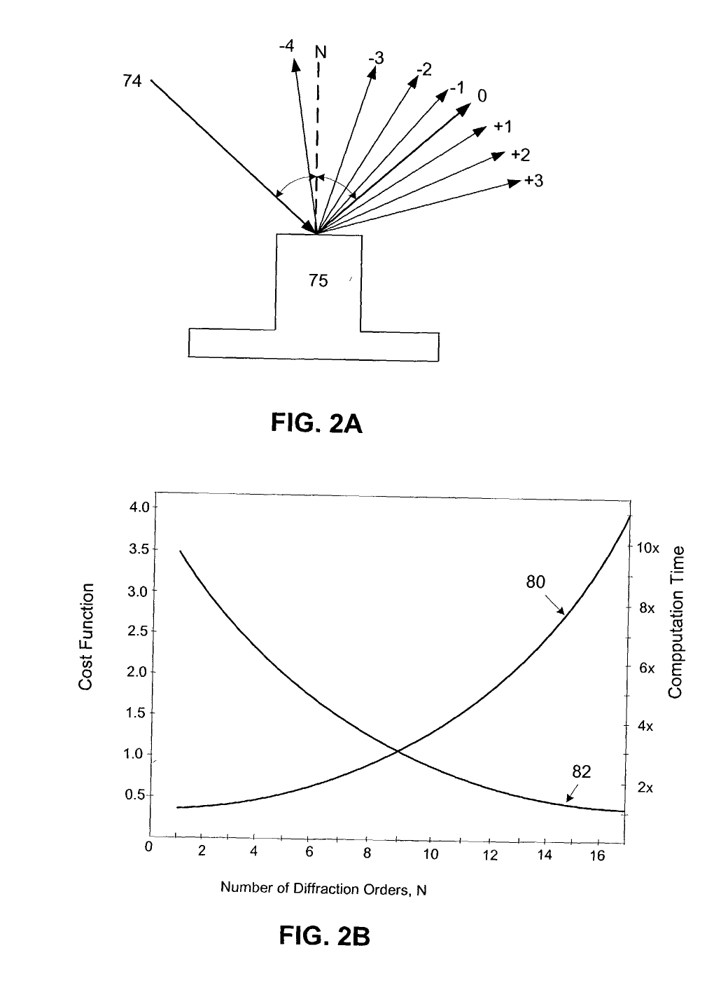

FIG. 2A is an architectural diagram illustrating orders of a diffraction signal off a periodic structure. An incident metrology beam or signal 74 is projected at an incident angle on the structure 75 and is diffracted off the structure 75, wherein the diffracted signal comprises the zeroth order, designated as 0 in the illustration, being the diffracted beam with the angle of diffraction from the normal N the same as the incident beam 74. Several higher diffraction orders designated as +1, +2, +3, −1, −2, −3, and −4 are shown. Other higher diffraction orders and other orders known as evanescent orders are not shown in the illustration. Efficient generation of a simulated diffraction signal off the structure 75 for a given structure profile involves selecting diffraction orders for each wavelength that provide sufficient diffraction information without overly increasing the computational steps to perform diffraction simulations.

FIG. 2B includes a graph illustrating cost as a function of the number of diffraction orders and a graph illustrating time required to create a library of simulated diffraction signals as a function of the number of diffraction orders considered in the calculations, assuming a given computer system. Referring to FIG. 2B, the cost function is represented in the left-hand Y-axis as a function of the number of diffraction orders in the X-axis. One cost function comparison is illustrated by the equations below, where V₁ and V₂ are two vectors of size n, and the cost function of V₁ relative to V₂ is:

$$Cost ( {V}_{1} , {V}_{2} ) = {\sum }_{i = 1}^{n} {( {V}_{1 i} - {V}_{2 i} )}^{2} . \qquad ( 1.00 )$$

In this example, the first vector is a set of signal values simulated for the metrology device used and assuming an infinite number of diffraction orders, referred to as the reference signal, whereas the second vector is another set of simulated signal values at the same points in the signal for the same metrology device but using a given number of diffraction orders less than that used in the reference signal.

Graph line 82 illustrates that the cost function is high when few diffraction orders are included but the cost function quickly decreases with increasing number of diffraction orders until at some number of diffraction order, the diffraction cost function levels off to a convergence value (not shown). Graph line 80 illustrates how the computation time represented in right-hand Y-axis is typically low with a few number of orders included and rapidly increases in a non-linear fashion as the number of diffraction orders increases. Since the selection of diffraction orders is influenced by a number of variables specific to the structure, metrology device, and IC fabrication properties, there is a need for an efficient and repeatable process to select the diffraction orders per wavelength for each application.

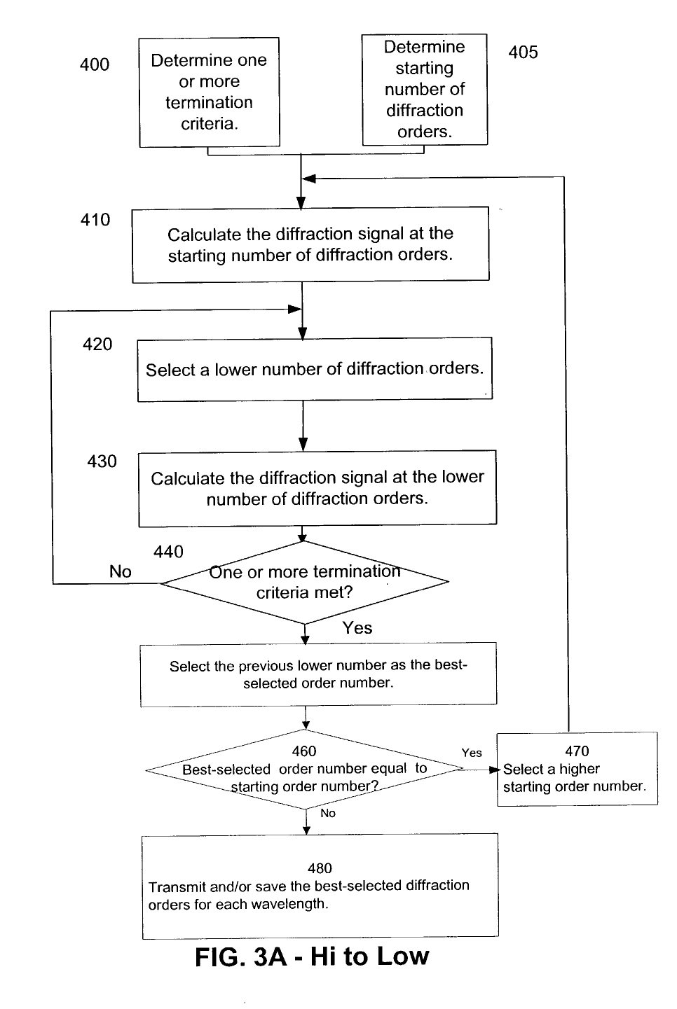

FIGS. 3A and FIG. 3B are flow charts of exemplary processes to select diffraction orders for optical metrology calculations. FIG. 3A is a flow chart of an exemplary process using a high starting number of diffraction orders whereas FIG. 3B is a flow chart of an exemplary process using a low starting number of diffraction orders.

Two types of diffraction order selections are discussed, namely, symmetrical and asymmetrical diffraction order selection. Symmetrical selection refers to the process where the positive and negative higher orders are selected in pairs plus the zeroth order. Asymmetrical selection considers each diffraction order separately and thus, the selected orders may include more of either the positive or negative orders.

Referring to FIG. 3A, in step 400, one or more termination criteria for the diffraction order selection process is determined. A termination criterion is a yardstick against which the result of the selection process is measured. The termination criteria may include a cost function value, a Goodness-of-Fit (GOF) value, and/or other curve fitting metrics. A cost function termination criterion may be set at a specific number, for example, 1.00. Another termination criterion may be the goodness of fit (GOF) between the simulated diffraction signal values using one set diffraction orders and another simulated diffraction signal using a different set of diffraction orders. The GOF is a measure of the proximity of two sets of values. For example, when ellipsometric measurements are used, GOF is based on values for tan ψ and cos Δ, where tan ψ and cos Δ are represented by a single vector of 2n dimensions:

S=[tan ψ₁ tan ψ₂ . . . tan ψₙ cos Δ₁ cos Δ₂ . . . cos Δₙ. (1.10)

One commonly used formula for GOF between a simulated diffraction signal Sₘ compared to another simulated diffraction signal Sₛ, is:

$$\begin{matrix}GOF = 1 - \frac{{\sum }_{i}^{n} {( {S}_{s} ( i ) - {S}_{m} ( i ) )}^{2}}{{\sum }_{i}^{n} {( {S}_{m} ( i ) - {\overline{S}}_{m} )}^{2}} & ( 2.00 ) \\ where {\overline{S}}_{m} = \frac{{\sum }_{i}^{n} {S}_{m} ( i )}{n} & ( 2.10 )\end{matrix}$$

where i represents the i th measurement point for an optical metrology device, n is the total number of measurements for the optical metrology device.

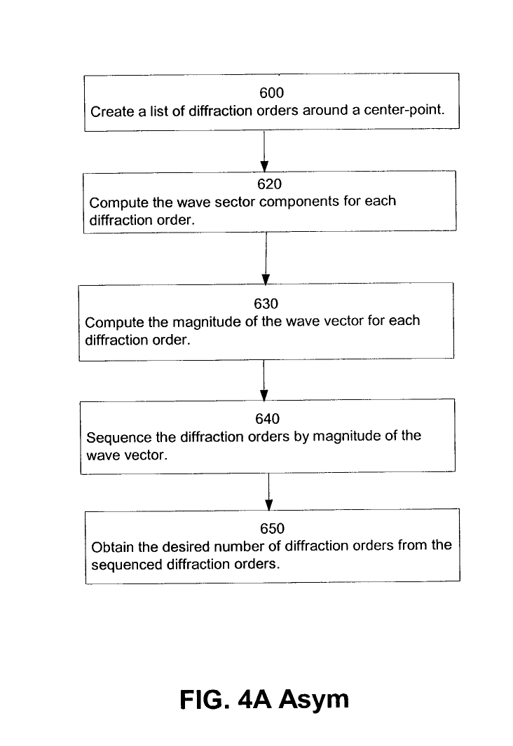

In step 405 of FIG. 3A, the starting number of diffraction orders is determined for a specific wavelength. For example, at a wavelength of 300 nanometers (nm), a starting diffraction order number may be set at 31, comprising 15 positive, 15 negative, and the zeroth order for symmetrical order selection. For asymmetrical order selection, the starting diffraction order number may be set at 30, 31, or 32 orders. However, the composition of the starting diffraction orders for asymmetrical selection is determined in a process depicted in FIGS. 5A and 5B below and may include more positive or negative diffraction orders. In step 410, the simulated reference diffraction signal using the starting number of diffraction orders is calculated. For a detail description of the calculations to simulate a diffraction signal; refer to co-pending U.S. patent application Ser. No. 09/770,997, entitled “Caching of Intra-layer Calculations for Rapid Rigorous Couple-Wave Analyses”, by Niu et al., filed on Jan. 26, 2000, which is incorporated herein in its entirety by reference.

Still referring to FIG. 3A, in step 420, a lower number of diffraction orders as compared to the starting number is selected. The lower number may be selected by using any of several processes such as decrementing successively the starting number by 1, 2 or 3 every iteration as an example. Alternatively, the lower number may be determined using binary search techniques or similar methods. In step 430, the new simulated diffraction signal using the lower number of diffraction orders is calculated using the technique applied in step 410.

In step 440, the one or more termination criteria are tested using the reference and new diffraction signals calculated in steps 410 and 430. For example, if only one termination criterion is used such as the cost function being greater than 2.00, then the cost function of the simulated diffraction signal using the starting order versus the simulated diffraction signal using the lower order is calculated and compared to 2.00. In another case, there may be two termination criteria such as the cost function being greater than 2.00 and the GOF of the same two simulated diffraction signals lower than say 0.95.

In step 440, if the one or more termination criteria are met, then the processing proceeds to step 450, otherwise, steps 420, 430, and 440 are iterated.

In step 450, the previous lower order number is selected as the best-selected order number. For example, if the first lower order number is 29 and the termination criteria are not met, then steps 420, 430, and 440 are iterated. Suppose further that the second lower order number is 27 and this time the termination criteria are met, then 29 is the previous lower order and is selected as the best-selected order number for the wavelength. In step 460, the best-selected order number is compared with the starting order number and if equal, meaning the starting order number is set too low, processing proceeds to step 470 where a higher starting order number is selected. As an illustration, if after the first iteration with the first lower order number at 29 the termination criteria are met, then the previous lower number is 31 and is the same as the starting order number of 31. In this case, processing proceeds to step 470 where a starting order number higher than 31 is selected. The choice of starting order numbers is specific to the application and is affected by fabrication process, type of metrology device, and the like. Based on experience with the particular application, a sequenced set of starting order numbers may be used. Following the example above, the sequenced set of starting order numbers may be 31, 41, or 51 order numbers. After selection of a higher starting order number is completed, processing proceeds to step 410 where steps 410 through 450 are iterated. If the best-selected order number is not equal to the starting order number, processing proceeds to step 480 where the best-selected diffraction orders for the wavelength the wavelength are transmitted and/or saved.

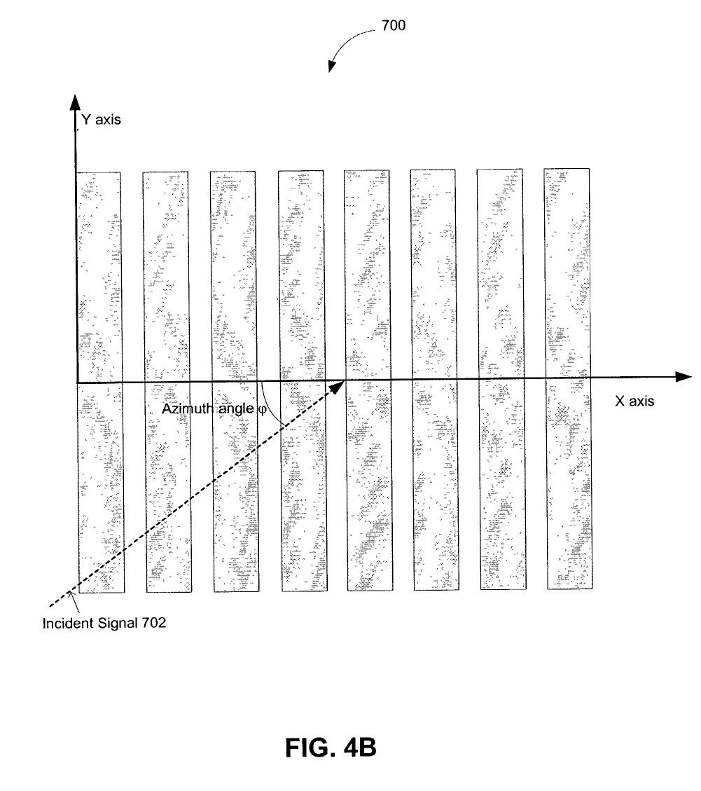

The process illustrated in FIG. 3A is performed for each wavelength included in the simulation of the diffraction signal. Moreover, the processing for all the wavelengths considered is iterated for the TM and TE components of the signal when ellipsometric metrology is used. Identification data related to fabrication process, structure, and optical metrology device may also be transmitted and/or saved in step 480. A fabrication process identifier may be a specific lithography or etch process, a structure identifier may be an identifier of the site where the structure is located or an identifier of the type of IC device, and the optical metrology device may be a specific reflectometer or ellipsometer. More information of the data saved is discussed in the description for FIG. 6.

FIG. 3B is a flow chart of an exemplary process of selecting diffraction orders using a low starting number of diffraction orders. This technique may shorten the number of steps needed to determine the best-selected orders. Processing is very similar to the general sequence of steps depicted in FIG. 3A and differences will be noted.

Referring to FIG. 3B, in step 500, one or more termination criteria for the diffraction order selection process is determined. As before, the termination criteria may include a cost function value, a Goodness-of-Fit (GOF) value, and/or other curve fitting metrics. In step 505 of FIG. 3B, the starting number of diffraction orders is determined for a specific wavelength. For example, at a wavelength of 300 nm, a starting diffraction order number may be set at 9, comprising 4 positive, 4 negative, and the zeroth order for symmetrical order selection. For asymmetrical order selection, the starting diffraction order number may be set at 9, 11, or 13 orders, for example. However, the composition of the starting diffraction orders for asymmetrical selection is determined in a process depicted in FIGS. 5A and 5B below and may include more positive or negative diffraction orders. In step 510, the simulated diffraction signal using the starting number of diffraction orders is calculated in a manner similar to step 410 of FIG.3A.

Still referring to FIG. 3B, in step 520, a higher number of diffraction orders as compared to the starting number are selected. The higher order number may be selected by using any of several processes such as incrementing successively the starting number by 1, 2 or 3 during every iteration, for example. Alternatively, the higher number may be determined using binary search techniques or similar methods. In step 530, the simulated diffraction signal using the higher number of diffraction orders is calculated using the technique applied in step 510.

In step 540, the one or more termination criteria are tested using the diffraction signals calculated in steps 510 and 530. For example, if only one termination criterion is used such as the cost function being less than 2.00, then the cost function of the simulated diffraction signal using the starting order versus the simulated diffraction signal using the higher order is calculated and compared to 2.00. In another case, there may be two termination criteria such as the cost function being less than 2.00 and the GOF of the same two simulated diffraction signals higher than say 0.95. In step 540, if the one or more termination criteria are met, then the processing proceeds to step 550, otherwise, steps 520, 530, and 540 are iterated.

In step 550, the previous higher order number is selected as the best-selected order number. For example, if the first higher order number is 9 and the termination criteria are not met, then steps 520, 530, and 540 are iterated. Suppose further that the second higher order number is 11 and this time the termination criteria are met, then 9 is the previous higher order and is selected as the best-selected order number for the wavelength.

In step 560, the best-selected order number is compared with the starting order number and if equal, meaning the starting order number is set too high, processing proceeds to step 570 where a lower starting order number is selected. In the example above, if after the first iteration with the first higher order number at 11, the termination criteria are met, then the previous higher number is 9, i.e., the same as the starting order number. In this case, in step 570, a starting order number lower than 9 is selected. The choice of starting order numbers is specific to the application and is affected by fabrication process, type of metrology device, and the like. Based on experience with the particular application, a sequenced set of starting order numbers may be used. Following the example above, the sequenced set of starting order numbers may be 9, 21, or 41 order numbers. After selection of a higher starting order number is completed, processing proceeds to step 510 where steps 510 through 550 are iterated. If the best-selected order number is not equal to the starting order number, processing proceeds to step 580 where the best-selected diffraction orders for the wavelength are transmitted and/or saved.

Similar to the first process described, the selection of orders is performed for each wavelength included in the simulation of the diffraction signal. Moreover, the processing for all the wavelengths considered is iterated for the TM and TE components of the signal when ellipsometric metrology is used.

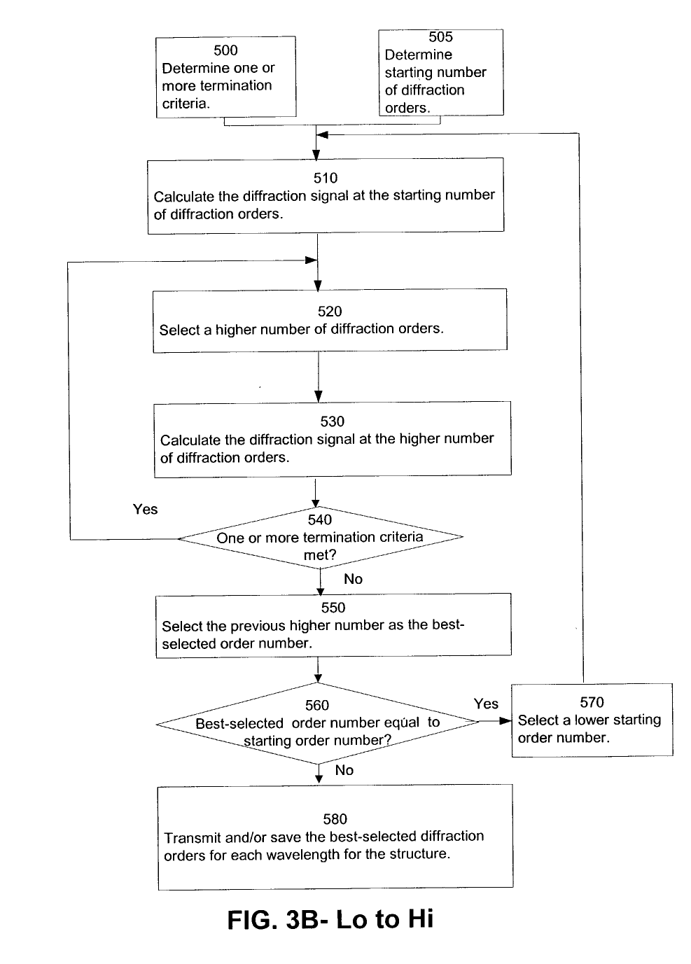

FIG. 4 is an exemplary flow chart for determining the diffraction orders to include in asymmetrical order selection. As stated before, asymmetrical order selection may include different number of positive and negative orders plus the zeroth order. An exemplary method for selecting which orders should be included is the center-point of the diffraction orders technique. In step 600, a list of specific diffraction orders around a center-point of diffraction orders is created based on the number of diffraction orders N desired. The center-point is located using the grating equation:

$$CP = int [ \frac{{n}_{0} P}{{λ}_{0}} Sin θ \cdot Cos ϕ ] \qquad ( 3.2 .0 )$$

where:

CP is the center-point diffraction order,

n₀ is the refractive index of air,

P is the period of the periodic structure,

λ₀ is the wavelength in free space,

θ is the angle of incidence, and

φ is the azimuthal angle,

Int(.) rounds the argument to an integer.

The given number of diffraction orders N around the center-point is chosen for the application, typically determined from data specific to the application, the metrology device used, and the specific structure in the wafer or workpiece. In one embodiment, N is a function of the starting number of diffraction orders referred to in the descriptions for FIGS. 3A and 3B. For example, if N is 5 and the center-point diffraction order CP according to Equation (3.2.0) is −1, then the list of diffraction orders around −1 is: [−6, −5, −4, −3, −2, −1,0, 1, 2, 3, 4].

In step 620, the wave sector components for each diffraction order in the list is computed using the following equations for the x and y components of a fixed coordinate system for a periodic structure, discussed below in relation to FIG. 4B:

$$\begin{matrix}{k}_{x} = {n}_{0} {k}_{0} Sin θ \cdot Cos ϕ - \frac{2 π}{{P}_{x}} \cdot Order & ( 3.2 .2 ) \\ {k}_{y} = {n}_{0} {k}_{0} Sin θ \cdot Sin ϕ - \frac{2 π}{{P}_{y}} \cdot Order & ( 3.2 .4 )\end{matrix}$$

where:

$${k}_{0} = \frac{2 π}{{λ}_{0}} ,$$

Order is the diffraction order expressed as an integer 1,2,3 . . . ,

kₓ is the wave vector component in the x dimension,

k_{y} is the wave vector component in the y dimension,

Pₓ is the period of the periodic structure in the x dimension, and

P_{y} is the period of the periodic structure in they dimension.

FIG. 4B is a top view of a periodic structure illustrating the fixed coordinate system. Looking at the top of a periodic structure 700, the Y-axis is parallel to the direction of the lines of the grating and the X-axis is along the direction of periodicity of the structure 700. The incident signal 702 has an azimuthal angle of φ relative the X-axis. In the previous example, the kₓ and k_{y} of the list-of orders [−6 −5, −4, −3, −2, −1, 0, 1, 2, 3, 4] would be calculated. With reference to FIG. 4, in step 630, the magnitude of the wave vector k for each diffraction order is computed using the equation:

$${\vert k \vert}_{Order} = \sqrt{{k}_{x}^{2} + {k}_{y}^{2}} \qquad ( 3.2 .6 )$$

For a detail description and derivation of the equations 3.2.0 to 3.2.6, refer to co-pending U.S. patent application Ser. No. 09/770,997, entitled “Caching of Intra-layer Calculations for Rapid Rigorous Couple-Wave Analyses”, by Niu et al., filed on Jan. 26, 2000, which is incorporated herein in its entirety by reference.

Still referring to FIG. 4, in step 640, the diffraction orders are sequenced based on the magnitude of the wave vector k. In step 650, the desired number of diffraction orders from the sequenced diffraction orders using the center-point is obtained. Using the list in the previous example, with the center-point order being −1 and the request for sequenced diffraction orders is 4, then [−6 −5, −4, −3, −2, −1, 0, 1, 2, 3, 4] would be obtained.

In one embodiment, the list is of diffraction orders around the center-point is large enough such that steps 600, 620, 630, and 640 are performed once per wavelength of the diffraction wave component, i.e., TM or TE, for the entire order selection process. For this embodiment, only step 650 where the desired number of diffraction orders from the sequenced diffraction orders using the center-point is obtained.

In another embodiment, the diffraction orders are sequenced by calculating the diffraction efficiency for each order. For a detailed description of the diffraction efficiency equations, refer to X. Niu 1999 thesis at UC Berkeley, “An Integrated System of Optical Metrology for Deep Sub-Micron Lithography”, pages 69-86, incorporated herein by reference in its entirety.

FIGS. 5A and 5B are graphs illustrating convergence of the TM component of the diffraction signal for a given wavelength as a function of diffraction orders. With reference to FIG. 5A, graph line 1030 shows that for a given structure, the value of the TM component of the diffraction signal at a wavelength of 240 nm varies from a low value of−0.45 to a high value of approximately −0.08 before converging to a value of approximately −0.23 as represented by the convergence line 1032. Points A, B, and C represents the simulated TM values at 5, 10, and 15 diffraction orders included in the simulation calculations, respectively. It should be noted that there is a noticeable difference of the TM value to the convergence value at point A, less difference at point B, and negligible difference at point C. Thus, if 5, 10, and 15 diffraction orders were chosen as the sequenced set of starting diffraction orders, depending on the termination criteria used, 5 or 10 or 15 would be selected as the starting diffraction order for symmetrical order processing.

With reference to FIG. 5B, graph line 1040 shows that for a structure, the value of the TM component of the diffraction signal at a wavelength of 240 nm varies from a low value of 0.220 to a high value of over 0.50 before converging to a value of approximately 0.455 as represented by the convergence line 1042. Points D, E, and F represents the simulated TM values at 5, 10, and 15 diffraction orders included in the simulation calculations, respectively. It should be noted that at point D, there is a noticeable difference of the TM value to the convergence value, minimal difference at point E, and negligible difference at point F. Thus, if 5, 10, and 15 diffraction orders were chosen as the sequenced set of starting diffraction orders, depending on the termination criteria used, 5 or 10 or 15 would be selected as the starting diffraction order for symmetrical order processing.

FIG. 6 is a selected diffraction order data store layout in an exemplary embodiment. The data store for selected diffraction orders includes identification information for the process and structure 1510 and for optical metrology device 1520. The process identification may refer to a specific lithography, etch, ion implantation or combination of fabrication processes. The structure identification may refer to a specific test grating on a specific site of the wafer or work piece whereas the metrology device identification 1520 may refer to a specific ellipsometer or reflectometer, in this case, a specific reflectometer. Also included are the termination criteria 1530, which may be a specific cost function and/or GOF. The data store includes a set of diffraction orders per wavelength 1540, which may be symmetrical or asymmetrical around the zeroth order.

Still referring to FIG. 6, the same structure may be measured with a different optical metrology device such as an ellipsometer. The optical metrology device identification 1550 and diffraction order termination criteria 1560 used to select the diffraction orders are similarly stored. The associated selected diffraction orders per wavelength for TE 1570 and for TM 1580 are stored separately. Similar to the selected diffraction orders stored for the case of a reflectometer above, the set of diffraction orders per wavelength, 1570 and 1580, always includes the zeroth order and may include symmetrical or asymmetrical higher orders.

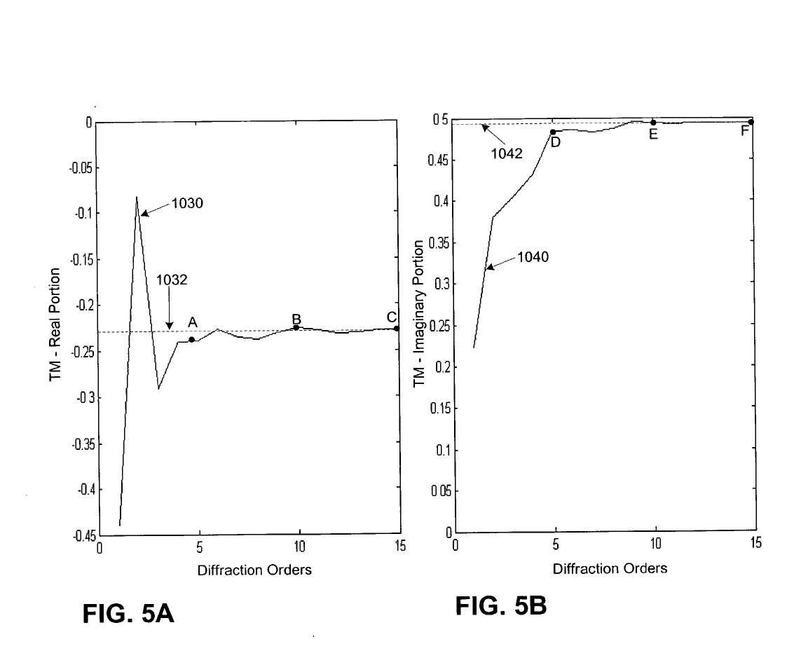

FIG. 7 is an architectural diagram of a diffraction order selector system in an exemplary embodiment. A diffraction order selector 123 accesses a profile data space 125 containing a set of structure profiles. The diffraction order selector 123 selects a set of profiles from the profile data space 125 and performs the selection of diffraction orders per wavelength utilizing the one or more input selection criteria and the one or more termination criteria 121. The selected diffraction orders per wavelength and identifying information of the fabrication process, structure, and optical metrology device are stored in the diffraction order data store 127.

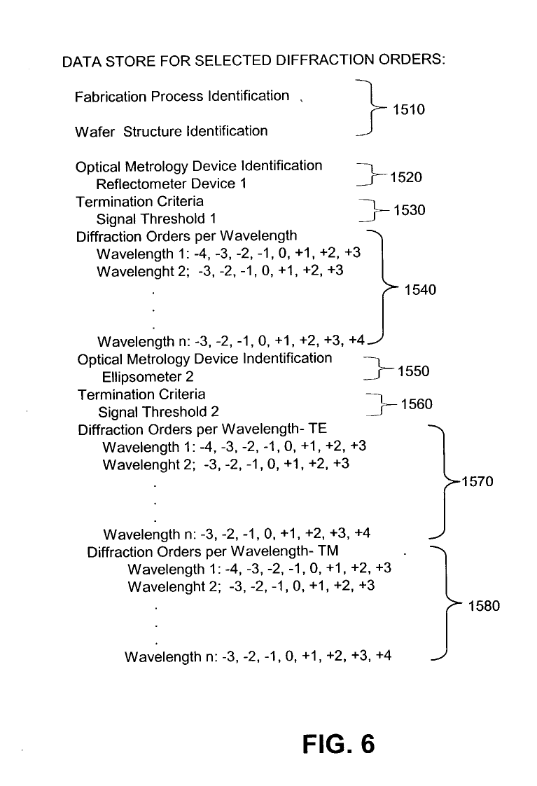

FIG. 8 is an architectural diagram illustrating an exemplary embodiment in a real-time critical dimension (CD) estimator. A real-time CD estimator 126 utilizing measured optical metrology signals 131 from an optical metrology system 129. The optical metrology system 129 may be similar to the optical metrology system described in FIG. 1, with a specific optical metrology device, such as an ellipsometer. The real-time CD estimator 126 accesses and transmits the diffraction order data store instances 133 from the diffraction order data store 132 using identification data from the input parameters 130 and computes the underlying film thickness 135 of the structure, CD 137 such as top width or bottom width of the structure, and the structure profile 139. For a detailed description of the process of determining real-time underlying film thickness, CD, and profile, refer to co-pending U.S. patent application Ser. No. 10/206,491, entitled “Model and Parameter Selection for Optical Metrology”, by Vuong et al., filed on Jul. 25, 2002, which is incorporated in its entirety herein by reference.

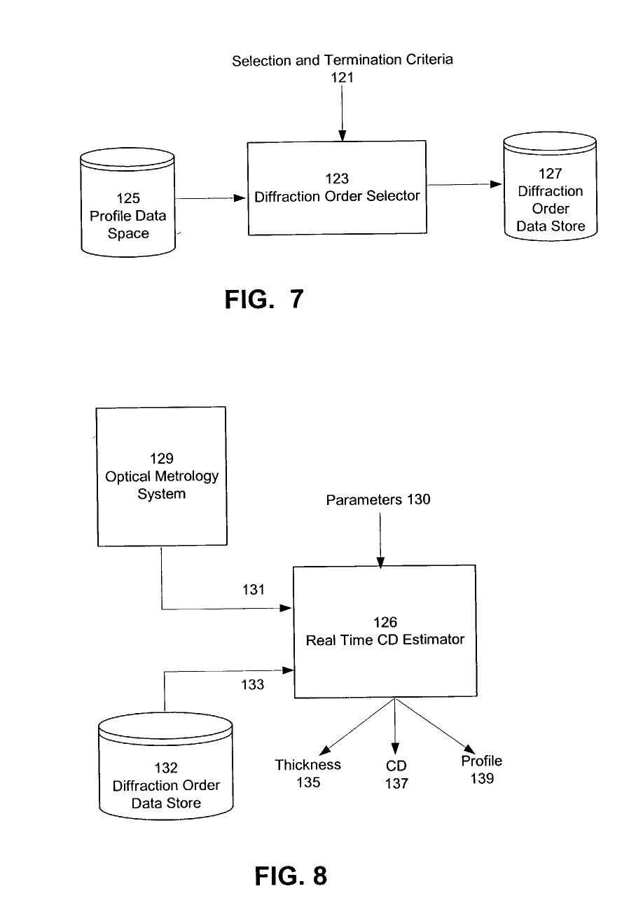

FIG. 9 is an architectural diagram of an exemplary embodiment for creating and using a library of simulated diffraction signals and profiles utilizing selected diffraction orders, the library in turn being used to determine the underlying film thickness, CD, and profile corresponding to the measured metrology diffraction signals. The diffraction order selector 903 uses input selection and termination criteria 902 and input structure profiles 901 to select the diffraction order per wavelength for a specific optical metrology device (not shown). From the diffraction order selector 903, the selected diffraction orders per wavelength and identification of the fabrication process, site, and metrology device 909 are stored in the diffraction order data store 921. Similar data 904 are also transmitted from the diffraction order selector 903 to the optical metrology simulator 905, which uses simulation parameters 907 to create pairs of profiles and corresponding simulated diffraction signals 913 to build a library 923.

Still referring to FIG. 9, an optical metrology system 941 similar to the system described in FIG. 1 transmits measured diffraction signals 947 to the profile applications server 949. Utilizing the library 923, the profile applications server 949 determines the best match diffraction signal in the library 923, accesses the associated profile data 933, and determines the underlying film thickness 961, CD 963, and profile 965 corresponding to the input measured diffraction signal 947. For a detailed description of the process of determining underlying film thickness, CD, and profile using a library, refer to copending U.S. patent application Ser. No. 10/206,491, entitled “Model and Parameter Selection for Optical Metrology”, by Vuong et al., filed on Jul. 25, 2002, which is incorporated in its entirety herein by reference.

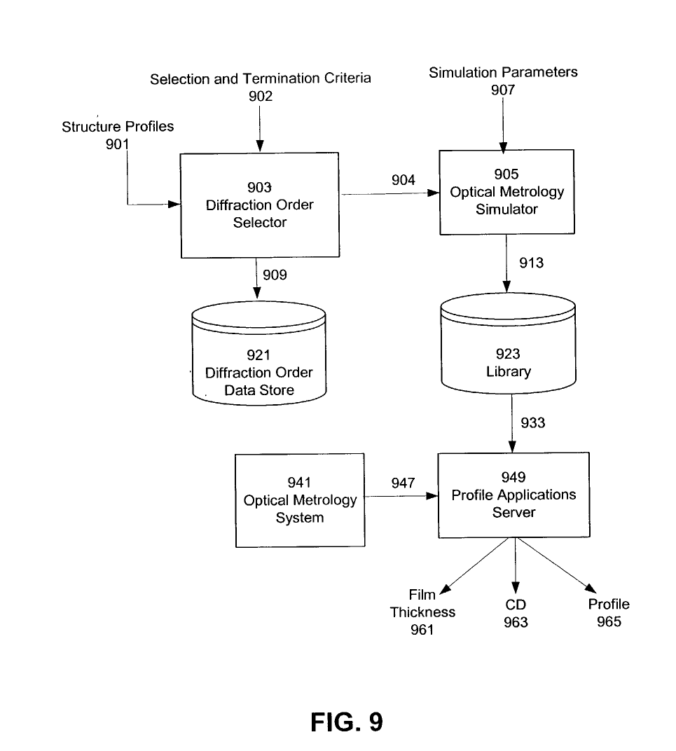

FIG. 10A is a graph illustrating the number of selected diffraction orders for the TE component of a diffraction signal in an exemplary embodiment utilizing an ellipsometer, whereas FIG. 10B is a graph illustrating the number of selected diffraction orders for the TM component of the diffraction signal as a function of wavelength. As can be seen in the FIG. 10A, in the graph for TE versus wavelength 970, the selected diffraction order number generally varies by wavelength although there are ranges of wavelengths where the selected diffraction order numbers are similar. Also noteworthy is that in graph 972 of FIG. 10B, the TM selected diffraction orders for a given wavelength are typically different than the TE selected diffraction orders for the same wavelength in FIG. 10A.

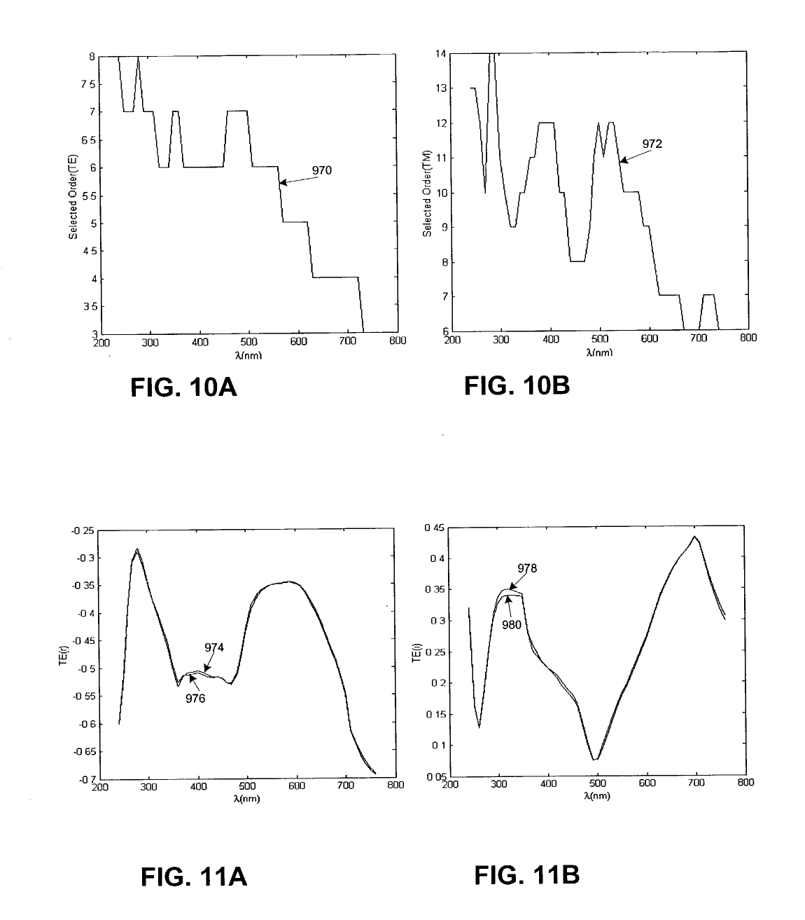

FIG. 11A and 11B are TE graphs illustrating the (complex number) real and imaginary portions respectively of two simulated diffraction signals off a hypothetical structure, one using fifteen diffraction orders for all wavelengths and the other using diffraction orders selected with the methods and principles of the present invention. Graph 974 illustrates the real portion representing TE simulated diffraction signal off a given hypothetical structure utilizing 15 diffraction orders consistently across all wavelengths, whereas graph 976 represents the real portion of the TE simulated diffraction signal off the same hypothetical structure utilizing selected diffraction orders per wavelength using the methods of the present invention. Visual comparison of graph 974 versus graph 976 shows that the two simulated diffraction signals are close. More rigorous comparisons of the two graphs may be done using statistical techniques such as sum-squared error, cost function, and the like.

Similarly, graph 978 in FIG. 11B represents the (complex number) imaginary portion of the TE simulated diffraction signal off the same hypothetical structure utilizing 15 diffraction orders consistently across all wavelengths whereas graph 980 represents the imaginary portion of the TE simulated diffraction signal off the same hypothetical structure utilizing selected diffraction orders per wavelength using the methods of the present invention. Visual comparison of graph 978 versus graph 980 shows that the two simulated diffraction signals are close. As mentioned above, more rigorous comparisons of the two graphs may be done using statistical techniques such as sum-squared error, cost function, and the like.

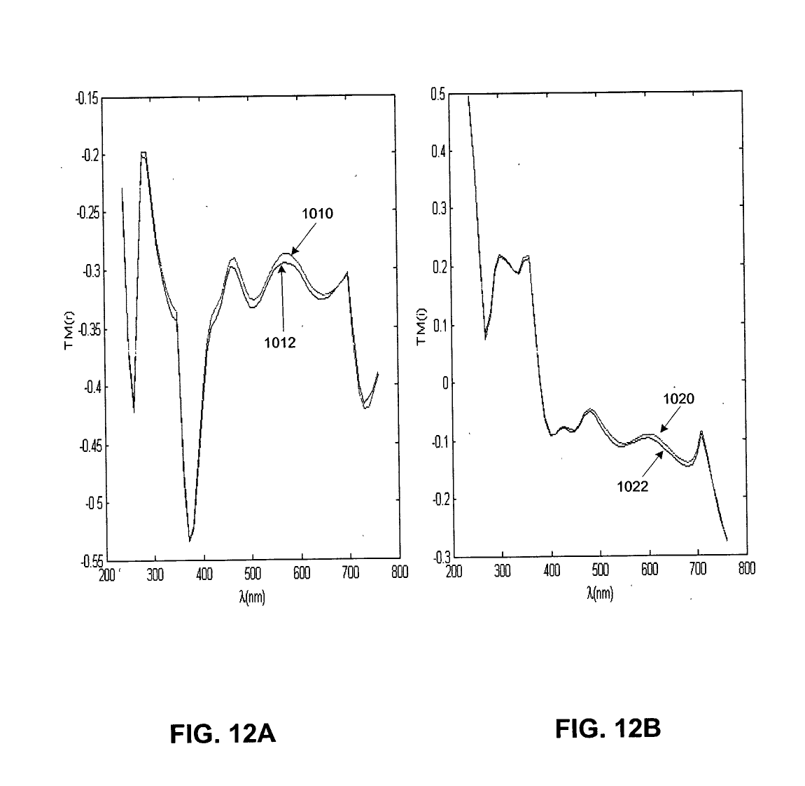

FIG. 12A and 12B are TM graphs illustrating the real and imaginary portions of two simulated diffraction signals off a hypothetical structure, one using fifteen diffraction orders for all wavelengths and the other using diffraction orders selected with the methods and principles of the present invention. Graph 1010 illustrates the real portion representing TM simulated diffraction signal off a given hypothetical structure utilizing 15 diffraction orders consistently across all wavelengths whereas graph 1012 represents the real portion of the TM simulated diffraction signal off the same hypothetical structure utilizing selected diffraction orders per wavelength using the methods of the present invention. Similarly, visual comparison of graph 1010 versus graph 1012 shows that the two simulated diffraction signals are close. Similarly, graph 1020 in FIG. 12B represents the complex number imaginary portion of the TM simulated diffraction signal off the same hypothetical structure utilizing 15 diffraction orders consistently across all wavelengths considered whereas graph 1022 represents the imaginary portion of the TM simulated diffraction signal off the same hypothetical structure utilizing selected diffraction orders per wavelength using the methods of the present invention. As before, visual comparison of graph 1020 versus graph 1022 shows that the two simulated diffraction signals are close. As mentioned above, more rigorous comparisons of the two graphs may be done using statistical techniques such as sum-squared error, cost function, and the like.

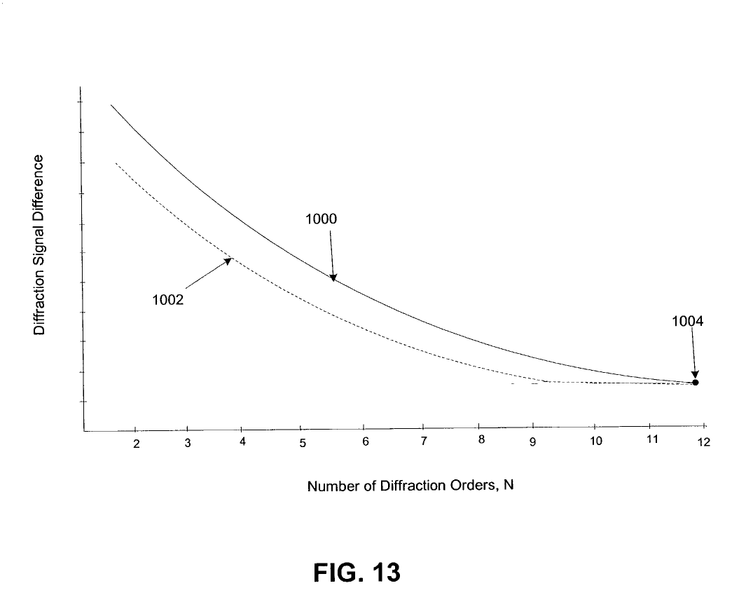

FIG. 13 is a graph illustrating diffraction signal difference as a function of the number of diffraction orders used in optical metrology calculations with one using symmetrical diffraction orders and another using asymmetrical diffraction orders. Graph 1000 represents the plot of the diffraction signal difference as a function of number of diffraction orders where the diffraction orders selected are symmetrical around the zeroth order. Graph 1002 represents the plot of the diffraction signal difference as a function of number of diffraction orders where the diffraction orders selected are asymmetrical around the zeroth order. As can be seen in the graphs, 1000 and 1002, graph 1002 converges to the relatively stable value of the diffraction signal difference represented by point 1004 faster than graph 1000. Because of the faster convergence, asymmetrically selected diffraction orders may result in less computation for optical metrology simulations, thus, speeding up run-time CD determination or speeding up creation of libraries of profiles and corresponding simulated diffraction signals.

It should be noted that when a reflectometer at normal incidence is used, the relative advantage of asymmetrical diffraction order selection is not effective since the resulting selections would be symmetrical orders.

Other embodiments include selection of diffraction orders where the range of wavelengths, 200 to 800 nm, is segmented into partitions. Each partition of wavelengths is treated as one set and diffraction order selection is done for the set instead of every wavelength. Another technique is to determine the highest number of symmetrical diffraction orders for the entire range of wavelengths and use this highest number for every wavelength.

Reduction of the number of diffraction orders used in optical metrology measurement, processing, and/or simulation can provide several advantages. For example, by selecting the diffraction orders per wavelength on a small sample of profiles, the selected diffraction orders may be used in a large set of profiles typically created for a production library. Due to the number of calculation steps eliminated, reduction of diffraction orders results in a polynomial reduction in time for creating a library. Additionally, the time needed for regression analysis to determine the CD's and other profile data of structures are similarly reduced by performing calculations only for the selected diffraction orders.

In particular, it is contemplated that functional implementation of the present invention described herein may be implemented equivalently in hardware, software, firmware, and/or other available functional components or building blocks. Other variations and embodiments are possible in light of above teachings, and it is thus intended that the scope of invention not be limited by this Detailed Description, but rather by claims following.

We claim:

1. A method of selecting diffraction orders of a diffraction signal for a given wavelength, the diffraction signal for use in optical metrology of a structure, wherein the diffraction orders comprise a zeroth diffraction order and higher positive and negative diffraction orders, the method comprising:
determining one or more termination criteria;
calculating a reference simulated diffracted signal using a starting number of diffraction orders;
determining a revised number of diffraction orders using the starting number of diffraction orders;
calculating a new simulated diffraction signal using the revised number of diffraction orders;
determining if the one or more termination criteria are met using the reference simulated diffracted signal and the new simulated diffraction signal; and
iterating the steps of determining the revised number of diffraction orders and calculating the new diffraction signal until the one or more termination criteria are met.

2. The method of claim 1 wherein selection of diffraction orders balances information content of the calculated diffraction signal versus the number of computation steps required for calculating a diffraction signal.

3. The method of claim 1 wherein the one or more termination criteria comprises:
testing if a cost function value of the reference diffraction signal compared to the new simulated diffraction signal is greater than a preset cost function value.

4. The method of claim 1 wherein the one or more termination criteria comprises:
testing if a goodness of fit value of the reference diffraction signal compared to the new simulated diffraction signal is less than a preset goodness of fit value.

5. The method of claim 1 wherein the starting number of diffraction orders is 31 or less.

6. The method of claim 1 wherein the starting number of diffraction orders is determined based on factors including type of fabrication, optical metrology device, and type of structure.

7. The method of claim 1 wherein calculating the reference simulated diffracted signal is performed using a rigorous coupled-wave analysis or differential technique.

8. The method of claim 1 wherein determining the revised number of diffraction orders using the starting number of diffraction orders comprises:
selecting a diffraction order number lower than the starting number of diffraction orders.

9. The method of claim 8 wherein selecting the diffraction order number lower than the starting number of diffraction orders utilizes a binary search technique.

10. The method of claim 8 wherein selecting the diffraction order number lower than the starting number of diffraction orders includes decrementing the starting number of diffraction with a preset number;
wherein the preset number is determined based on factors including type of fabrication, optical metrology device, and type of structure.

11. The method of claim 8 further comprising:
identifying a previous lower diffraction number as a best-selected order number;
testing if the best-selected order number is equal to the starting order number, and selecting a higher starting order number if the best-selected order is equal to the starting older number.

12. The method of claim 11 wherein the selected higher starting order number is obtained from a predetermined set of starting order numbers.

13. The method of claim 12 wherein the predetermined set of starting order numbers is developed based on factors including type of fabrication, optical metrology device, and type of structure.

14. The method of claim 1 wherein determining the revised number of diffraction orders using the starting number of diffraction orders comprises:
selecting a diffraction order number higher than the starting number of diffraction orders.

15. The method of claim 14 wherein selecting the diffraction order number higher than the starting number of diffraction orders utilizes a binary search technique.

16. The method of claim 14 wherein selecting the diffraction order number higher than the starting number of diffraction orders includes incrementing the starting number of diffraction with a preset number;
wherein the preset number is determined based on factors including type of fabrication, optical metrology device, and type of structure.

17. The method of claim 14 further comprising:
identifying a previous higher diffraction number as a best-selected order number;
testing if the best-selected order number is equal to the starting order number, and
selecting a lower starting order number if the best-selected order is equal to the starting older number.

18. The method of claim 17 wherein the selected lower starting order number is obtained from a predetermined set of starting order numbers.

19. The method of claim 19 wherein the predetermined set of starting order numbers is developed based on factors including type of fabrication, optical metrology device, and type of structure.

20. The method of claim 1 wherein the starting diffraction number and the revised number of diffraction orders include symmetrical higher orders and the zeroth order.

21. The method of claim 20 wherein the starting diffraction number and the revised number of diffraction orders include asymmetrical higher orders.

22. The method of claim 21 wherein the asymmetrical orders are determined using a wave vector algorithm.

23. The method of claim 22 wherein the wave vector algorithm includes the following steps:
determining a center-point of the diffraction orders;
determining a set of diffraction orders to be sequenced;
computing a wave vector magnitude for each diffraction order in the set of diffraction orders;
sorting in ascending sequence the set of diffraction orders based on the computed wave vector magnitude; and
obtaining a diffraction order subset of the sequenced set of diffraction orders;
wherein the number of diffraction orders in the diffraction order subset correspond to the revised number of diffraction orders.

24. The method of claim 1 wherein the reference simulated diffracted signal is simulated based on a reflectometric metrology device.

25. The method of claim 1 wherein the reference simulated diffracted signal is simulated based on an ellipsometric metrology device.

26. A method of selecting diffraction orders of a diffraction signal for selected wavelengths, the diffraction signal for use in optical metrology of a structure, the method comprising:
a) selecting a set of wavelengths from a range of wavelengths used in an optical metrology device;
b) for each wavelength of the selected set of wavelengths:
b1) determining one or more termination criteria for diffraction order selection;
b2) calculating a reference simulated diffracted signal using a starting number of diffraction orders;
b3) determining a revised number of diffraction orders based on the starting number of diffraction orders;
b4) calculating a new simulated diffraction signal using the revised number of diffraction orders; and
b5) iterating the steps b3) and b4) until the one or more termination criteria are met;
b6) if the one of more termination criteria are met:
designating a previous revised number of diffraction orders as the best-selected order number;
selecting a different diffraction order number as the new starting number of diffraction orders if the best-selected order number is the same as the starting number of diffraction orders;
b7) iterating steps b2) through b6) until the best-selected order number is not the same as the starting number of diffraction orders;
wherein selection of diffraction orders balances information content of the calculated diffraction signal versus the number of computation steps required for calculating a simulated diffraction signal; and
wherein the diffraction orders comprise a zeroth diffraction order and higher positive and negative diffraction orders.

27. The method of claim 26 wherein a member of the selected set of wavelengths represents a group of wavelengths with similar diffraction order simulation characteristics.

28. The method of claim 26 wherein steps a) and b) are performed separately for trans-magnetic (TM) and trans-electric (TE) components of the diffraction signal used in optical metrology.

29. The method of claim 26 further comprising
iterating step b) for a selected set of profiles of a wafer structure, generating a best-selected order number for each profile of the selected set of profiles; and
selecting the highest best-selected order number from the generated best-selected order number for each profile of the selected set of profiles.

30. The method claim 26 further comprising:
saving the selected highest best-selected order numbers for each wavelength.

31. The method of claim 30 further comprising:
saving identification data regarding fabrication process, structure location, and optical metrology device.

32. The method of claim 26 further comprising:
creating a library of structure profiles and corresponding simulated diffraction signals, the simulated diffraction signals calculated utilizing the best-selected diffraction orders.

33. The method of claim 32 further comprising:
obtaining a measured diffraction signal off the structure;
determining the best match simulated diffraction signal from the library; and
accessing the structure profile from the library that is associated with the best match simulated diffraction signal.

34. The method of claim 33 wherein the measured diffraction signal is obtained using an ellipsometer or reflectometer.

35. The method of claim 32 further comprising:
obtaining a measured diffraction signal off the structure;
performing an algorithm to determine underlying film thickness, critical dimensions, and profile of the structure based on simulated diffraction signals calculated using the best-selected diffraction orders.

36. The method of claim 1 wherein calculating the reference simulated diffracted signal is performed using a rigorous coupled-wave analysis or differential technique.

37. A computer-readable storage medium containing computer executable code to select diffraction orders of a diffraction signal for use in optical metrology by instructing the computer to operate as follows:
determining one or more termination criteria;
calculating a reference simulated diffracted signal using a starting number of diffraction orders;
determining a revised number of diffraction orders using the starting number of diffraction orders;
calculating a new simulated diffraction signal using the revised number of diffraction orders; and
iterating the steps of determining the revised number of diffraction orders and calculating the new diffraction signal until the one or more termination criteria are met;
wherein selection of diffraction orders balances information content of the calculated diffraction signal versus the number of computation steps required for calculating a simulated diffraction signal; and
wherein the diffraction orders comprise a zeroth diffraction order and higher positive and negative diffraction orders.

38. A computer-readable storage medium containing computer executable code to select diffraction orders of a diffraction signal for use in optical metrology by instructing the computer to operate as follows:
a) selecting a set of wavelengths from a range of wavelengths used in an optical metrology device;
b) for each wavelength of the selected set of wavelengths:
b1) determining one or more termination criteria for diffraction order selection;
b2) calculating a reference simulated diffracted signal using a starting number of diffraction orders;
b3) determining a revised number of diffraction orders based on the starting number of diffraction orders;
b4) calculating a new simulated diffraction signal using the revised number of diffraction orders; and
b5) iterating the steps b3) and b4) until the one or more termination criteria are met;
b6) if the one of more termination criteria are met:
designating a previous revised number of diffraction orders as the best-selected order number;
selecting a different diffraction order number as the new starting number of diffraction orders if the best-selected order number is the same as the starting number of diffraction orders;
b7) iterating steps b2) through b6) until the best-selected order number is not the same as the starting number of diffraction orders;
wherein selection of diffraction orders balances information content of the calculated diffraction signal versus the number of computation steps required for calculating a simulated diffraction signal; and
wherein the diffraction orders comprise a zeroth diffraction order and higher positive and negative diffraction orders.

39. A system for selecting the diffraction orders of a diffraction signal for use in optical metrology calculations, the system comprising:
a profile data space containing a set profiles of a structure; and
a diffraction order selector coupled to the profile data space, the diffraction order selector configured to obtain a sample of profiles for a structure, to select diffraction orders for each wavelength of a diffraction signal for each profile of the sample of profiles, the selection using one or more termination criteria; and to identify best-selected diffraction orders for each wavelength;
wherein the diffraction orders comprise a zeroth order, higher positive orders and higher negative orders.

40. The system of claim 39 further comprising:
a diffraction order data store configured to store data including the best-selected diffraction orders.

41. A system for determining critical dimensions of a structure using diffraction orders selected for optical metrology calculations, the system comprising:
an input device configured to transmit a set of diffraction orders per wavelength, the diffraction orders selected to optimize accuracy and speed of optical metrology simulations;
an optical metrology system configured to measure and transmit diffraction signals off structures; and
a critical dimension estimator coupled to the input device and the optical metrology systems, the critical dimension estimator configured to receive the set of diffraction orders per wavelength and measured diffraction signals, to use the set of diffraction orders per wavelength in performing an algorithm that determines underlying film thickness, critical dimensions, and profile of the structures corresponding to the received measured diffraction signals.

42. The system of claim 41 wherein the optical metrology system includes an ellipsometer.

43. The system of claim 41 wherein the optical metrology system includes a reflectometer.

44. The system of claim 41 wherein the input device is a diffraction order data store.

45. A system for determining critical dimensions of a structure using diffraction orders selected for optical metrology calculations, the system comprising:
a library comprising instances of profiles of a structure and corresponding simulated diffraction signals, the library created by calculating the simulated diffraction signal corresponding to each structure profile, the calculation of simulated diffraction signals using diffraction orders per wavelength, the diffraction orders selected to optimize accuracy and speed of optical metrology simulations;
an optical metrology system configured to measure and transmit diffraction signals off structures; and
a profile applications server coupled to the library and the optical metrology systems, the profile applications server configured to receive the measured diffraction signals, to use the library in performing an algorithm that finds the best match instance of the library, and determines the underlying film thickness, critical dimensions, and profile of the structures corresponding to the received measured diffraction signals.

46. The system of claim 45 wherein the optical metrology system includes an ellipsometer.

47. The system of claim 45 wherein the optical metrology system includes a reflectometer.

48. The system of claim 45 further comprising:
a profile data space containing a set of profiles of a structure;
a diffraction order selector coupled to the profile data space, the diffraction order selector configured to select diffraction orders for each wavelength of a diffraction signal using one or more selection criteria, and save and/or transmit the selected diffraction orders for each wavelength; and
an optical metrology simulator coupled to the diffraction order selector and the library, the optical metrology simulator configured to use the transmitted selected diffraction orders for each wavelength, to receive simulation parameters, and to perform optical metrology simulations to generate the library comprising instances of profiles of structures and corresponding simulated diffraction signals.

49. A computer-readable storage medium containing stored data including:
fabrication process identification data;
structure identification data;
optical metrology device identification data;
diffraction order termination criteria; and
diffraction orders per wavelength.
